(19) United States
(12) Patent Application Publication
(10) Pub. No.: US 2026/0112169 A1
(43) Pub. Date: Apr. 23, 2026

(54) CANDIDATE MONITORING SYSTEM AND METHOD

(71) Applicant: Altimetrik Corp., Southfield, MI (US)

(72) Inventors: Balaji Santhana Krishnan, Bangalore (IN); Varsha Sureshbabu, Chennai (IN); Mohamed Thoufeeq S, Chennai (IN); Subash B, Chennai (IN)

(21) Appl. No.: 19/235,568

(22) Filed: Jun. 11, 2025

Related U.S. Application Data
(60) Provisional application No. 63/709,079, filed on Oct. 18, 2024.

(51) Int. Cl. G06V 20/52; G06Q 10/1053; G06T 7/70; G06V 20/40; G06V 40/10

(52) U.S. Cl. CPC G06V 20/52; G06Q 10/1053; G06T 7/70; G06V 20/40; G06V 40/10; G06T 2207/10016; G06T 2207/30201; G06T 2207/30232

(57) ABSTRACT

Provided are a candidate monitoring system and a candidate monitoring method. The candidate monitoring method may include acquiring video data including a plurality of video frames associated with a virtual interview. The candidate monitoring method may further include determining proctored data based on the acquired video data. The determined proctored data may include a set of video frames, of the plurality of video frames, in which frames with a candidate indulging in one or more malpractices are present. Furthermore, the candidate monitoring method may include generating, based on the determined proctored data, at least one report and transmitting the at least one report to a recruiter terminal.

### TECHNICAL FIELD

The present disclosure generally relates to video conferencing systems and methods, and more particularly relates to systems and methods for monitoring candidates during video conferencing.

### BACKGROUND

The global pandemic drastically altered the traditional hiring practices, leading many employers to shift from the traditional in-person interviews to virtual interviews. Video conferencing systems emerged as an indispensable solution for conducting the virtual interviews. Currently, there are various video conferencing systems that enable a recruiter to communicate with a candidate located at a remote location without any hassle.

However, these video conferencing systems lack the functionality of monitoring the candidate during the interview process. Taking advantage of this shortcoming of the video conferencing systems, many candidates indulge in one or more malpractices such as utilizing multiple display and audio devices, engaging in keystrokes manipulated by another person, frequently moving eyes beyond the screen, using mobile phone for an external aid, etc. Accordingly, there is a need for a system that monitors the candidate during virtual interviews.

### SUMMARY

Various embodiments of the present disclosure provide a system and a method for monitoring candidates during virtual interviews. It is an objective of these embodiments to identify whether a candidate is involved in one or more malpractices during virtual interviews. To that end, some embodiments acquire video data including a plurality of video frames. For instance, the video data may be acquired for an entire duration of the virtual interview. The acquired video data may be used to determine proctored data. In some example embodiments, the determined proctored data may include a set of video frames, of the plurality of video frames, in which the candidate indulging in the one or more malpractices are present.

In order to determine the proctored data, some embodiments execute a plurality of detection processes. For instance, the plurality of detection processes may include a candidate feature detection process, an object detection process, a person detection process, and/or an I/O device detection process. In an embodiment, the candidate feature detection process may be executed to identify whether the candidate is looking at a screen (or a monitor) of a candidate terminal or not. In an embodiment, the object detection process may be executed to identify whether the candidate is using an additional electronic device, such as a mobile phone, a laptop, or the like. In an embodiment, the person detection process may be executed to identify whether there is another person in the same room as the candidate. In an embodiment, the I/O device detection process may be executed to identify a number of I/O devices connected to the candidate terminal.

Some embodiments aim to generate at least one report based on the determined proctored data. In some example embodiments, the generated at least one report may include one or more representations depicting one or more outputs of the plurality of detection processes. In some other example embodiments, the generated at least one report may include a candidate monitoring result including one of first information indicating that the candidate is involved in the one or more malpractices or second information indicating that the candidate is not involved in the one or more malpractices. Some embodiments aim to transmit the generated at least one report to a recruiter terminal. For instance, the at least one report may be transmitted to the recruiter terminal via an email or the like.

Certain embodiments of the disclosure may disclose a system. The system comprises a memory and at least one processor that is coupled to the memory. The memory is configured to store computer-executable instructions. The at least one processor is configured to execute the computer-executable instructions to acquire video data comprising a plurality of video frames of a candidate. The at least one processor is further configured to execute the computer-executable instructions to determine, based on the acquired video data, proctored data. The proctored data includes a set of video frames of the plurality of video frames. The set of video frames is indicative of the candidate being involved in one or more malpractices. The at least one processor is further configured to execute the computer-executable instructions to generate, based on the proctored data, at least one report. The at least one processor is further configured to execute the computer-executable instructions to transmit, the generated at least one report to a recruiter associated with the candidate.

In numerous embodiments, a method for monitoring a candidate during an interview process is disclosed. The method comprising acquiring, by at least one processor, video data comprising a plurality of video frames of the candidate. The method further includes determining, by the at least one processor, based on the acquired video data, proctored data. The proctored data includes a set of video frames of the plurality of video frames. The set of video frames is indicative of the candidate being involved in one or more malpractices. The method further includes generating, by the at least one processor, based on the proctored data, at least one report. The method further includes transmitting, by the at least one processor, the generated at least one report to a recruiter associated with the candidate.

In this way, the system and method of the present disclosure may identify whether the candidate is involved in the one or more malpractices or not, and may transmit the candidate monitoring result to the recruiter terminal. Thereby, the employer (or a recruiter) associated with the recruiter terminal is provided with the candidate monitoring result which in turn enables the employer to decide whether to consider the candidate for one or more jobs associated with the employer. Accordingly, the system and method enable filtering out false candidate(s) in the employee recruitment process. Therefore, the system and method improve the productivity and resource planning for the employers.

### BRIEF DESCRIPTION OF THE DRAWINGS

The following detailed description of the embodiments of the present disclosure will be better understood when read in conjunction with the appended drawings. The present disclosure is illustrated by way of example, and not limited by the accompanying figures, in which like references indicate similar elements.

FIG. 1 illustrates a network environment for video conferencing between a candidate terminal and a recruiter terminal, in accordance with an embodiment of the present disclosure;

FIG. 2A illustrates a flowchart depicting a process of a candidate monitoring application, in accordance with an embodiment of the present disclosure;

FIG. 2B illustrates a flowchart depicting a process for executing a plurality of detection processes, in accordance with an embodiment of the present disclosure;

FIG. 2C illustrates a flowchart depicting a candidate feature detection process of the candidate monitoring application, in accordance with an embodiment of the present disclosure;

FIG. 2D illustrates a flowchart depicting a person detection process of the candidate monitoring application, in accordance with an embodiment of the present disclosure;

FIG. 2E illustrates a flowchart depicting an object detection process of the candidate monitoring application, in accordance with an embodiment of the present disclosure;

FIG. 2F illustrates a flowchart depicting an I/O device detection process of the candidate monitoring application, in accordance with an embodiment of the present disclosure;

FIG. 3A illustrates a representation depicting an output of the candidate feature detection process, in accordance with an embodiment of the present disclosure;

FIG. 3B illustrates a representation depicting an output of the person detection process, in accordance with an embodiment of the present disclosure;

FIG. 3C illustrates a representation depicting an output of the object detection process, in accordance with an embodiment of the present disclosure;

FIG. 4 illustrates a flowchart depicting a process for determining a candidate monitoring result, in accordance with an embodiment of the present disclosure; and

FIG. 5 illustrates a workflow for monitoring a candidate using the candidate terminal, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, “for instance”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

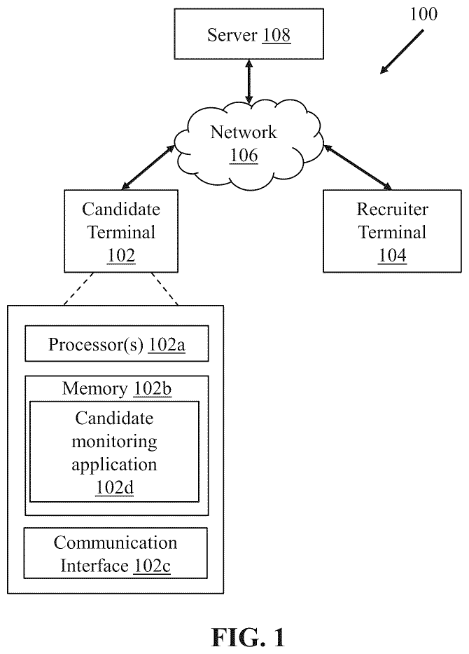

FIG. 1 illustrates a network environment 100 for video conferencing between a candidate terminal 102 and a recruiter terminal 104, in accordance with an embodiment of the present disclosure. As illustrated in FIG. 1, the network environment 100 may include the candidate terminal 102, the recruiter terminal 104, a network 106, and a server 108. The candidate terminal 102 may correspond to a portable device or a non-portable device that is capable of executing at least one software application. For instance, the candidate terminal 102 may be a smartphone, a laptop, a tablet, a Personal Computer (PC), or the like. In an embodiment, the at least one software application may include a video conferencing application and/or a web browsing application. As used herein, ‘video conferencing application’ may be a software code, which upon execution enables a live visual connection between two or more parties located at different locations. As used herein, ‘web browsing application’ may be a software code, which upon execution enables accessing a web-based interface rendered by the server 108. The server 108 may include suitable logic, circuitry, and/or interfaces to execute a server application. For instance, the server 108 may include computers, laptops, mini-computers, mainframe computers, cloud-based servers, distributed server networks, a network of computer systems, and/or the like. As used herein, ‘server application’ may be a software code that performs functions of a web server and/or an application server. For instance, the server application may provide video conferencing services between the candidate terminal 102 and the recruiter terminal 104.

In an embodiment, the candidate terminal 102 may be communicatively coupled to the recruiter terminal 104 and/or the server 108 via the network 106. The network 106 may be a medium through which information is transmitted between the candidate terminal 102, the recruiter terminal 104, and the server 108. For instance, the network 106 may include a local area network (LAN), a wide area network (WAN), a metropolitan area network (MAN), a satellite network, the Internet, a fiber optic network, a coaxial cable network, an infrared (IR) network, a radio frequency (RF) network, and/or the like. Various entities in the network environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, New Radio (NR) communication protocols, and/or the like.

In an embodiment, the candidate terminal 102 may be associated with a candidate. As used herein, ‘candidate’ may correspond a job seeker who is actively or non-actively looking for a job. As used herein, ‘job’ may correspond to a paid task or a paid work provided by an employer. As used herein, ‘employer’ may be an organization that employs people. In an embodiment, the recruiter terminal 104 may be associated with the employer. The recruiter terminal 104 may include suitable logic, circuitry, and/or interfaces to execute the at least one software application. For instance, the recruiter terminal 104 may be a smartphone, a laptop, a tablet, a Personal Computer (PC), a server, or the like.

The candidate terminal 102 may be remotely located from the recruiter terminal 104. To that end, one or both of the candidate terminal 102 and the recruiter terminal 104 may execute the at least one software application for enabling the live visual connection between the candidate and the employer. According to some embodiments, the live visual connection between the candidate and the employer is established for a candidate interview. As used herein, ‘candidate interview’ may correspond to interviewing the candidate to check if the candidate is suitable for one or more jobs associated with the employer. Since the candidate is interviewed through the at least one software application, the candidate may involve in one or more malpractices during the candidate interview. As used herein, ‘one or more malpractice’ may correspond to a malicious behavior, such as utilizing multiple display and audio devices, engaging in keystrokes manipulated by another person, frequently moving eyes beyond the screen, using mobile phone for an external aid, and/or the like. It is an objective of some embodiments to identify whether the candidate is involved in the one or more malpractices during the candidate interview. To that end, in some embodiments, the candidate terminal 102 may be configured to identify whether the candidate is involved in the one or more malpractices during the candidate interview.

The candidate terminal 102 may include at least one processor 102a, a memory 102b, and a communication interface 102c. The at least one processor 102a may include one or more single or multi-core central processing units (CPUs), application specific integrated circuits (ASICs), field programmable gate arrays (FPGAs), and/or the like. The memory 102b may include non-volatile memory, volatile memory, read only memory (ROM), random access memory (RAM), flash memory, magnetic storage, and/or any other suitable memory. The communication interface 102c may be an I/O interface for communicating with one or more I/O devices and/or may be a network interface for communicating with one or more external devices (such as the server 108 and/or the recruiter terminal 104). The I/O devices may include a monitor, a mouse, a keyboard, a camera, a touchpad, a speaker, a microphone, a joystick, and/or the like. In one embodiment, the I/O devices may be a part of the candidate terminal 102. For instance, the I/O devices may be included in the candidate terminal 102. In another embodiment, the I/O devices may be connected to the candidate terminal 102 via a wired connection or a wireless connection.

In an embodiment, the memory 102b may be configured to store a candidate monitoring application 102d. The candidate monitoring application 102d may correspond to computer-executable instructions. That is to say, the memory 102b may be configured to store the computer-executable instructions. The at least one processor 102a may be configured to execute the candidate monitoring application 102d for real-time candidate monitoring during the candidate interview. Upon execution of the candidate monitoring application 102d, the at least one processor 102a may be configured to identify whether the candidate associated with the candidate terminal 102 is involved in one or more malpractices during the candidate interview. Further, the at least one processor 102a may be configured to generate report(s) for the employer based on the results of the identification. For instance, the candidate monitoring application 102d may be a software code for identifying whether the candidate associated with the candidate terminal 102 is involved in one or more malpractices. In one embodiment, the candidate monitoring application 102d may be a part of the at least one software application. For instance, the candidate monitoring application 102d may be a plug-in to the at least one software application (i.e., the video conferencing application and/or the web browsing application). In another embodiment, the candidate monitoring application 102d may include the functionalities of the at least one software application. For instance, upon the execution, the candidate monitoring application 102d may enable the live visual connection between the candidate and the employer.

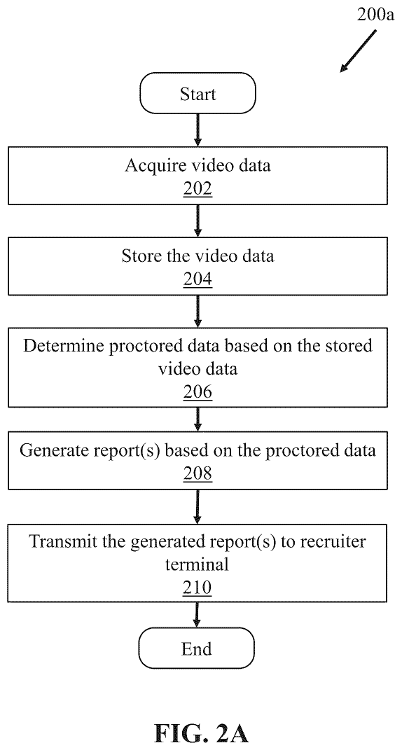

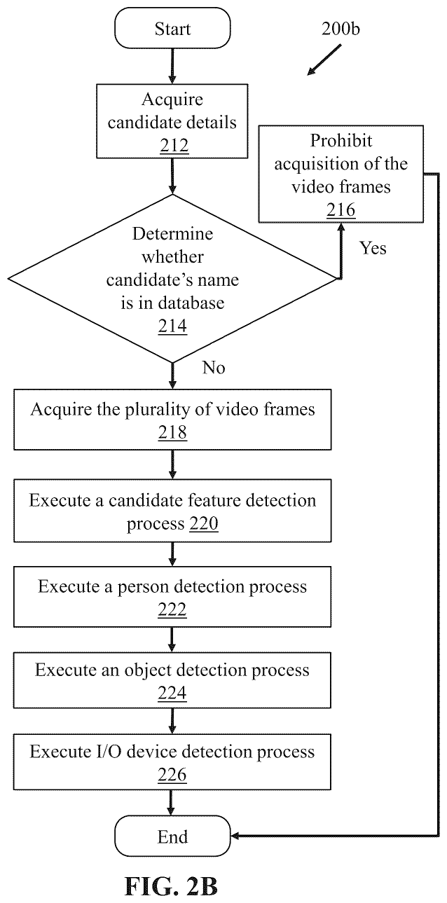

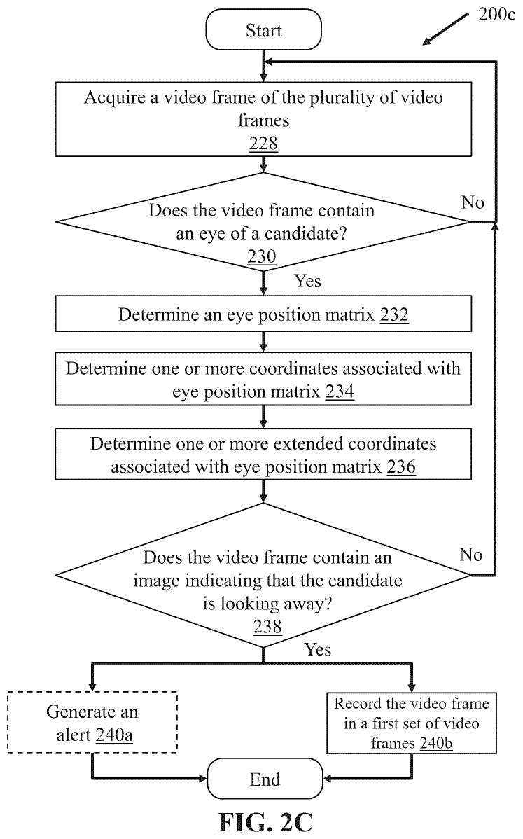

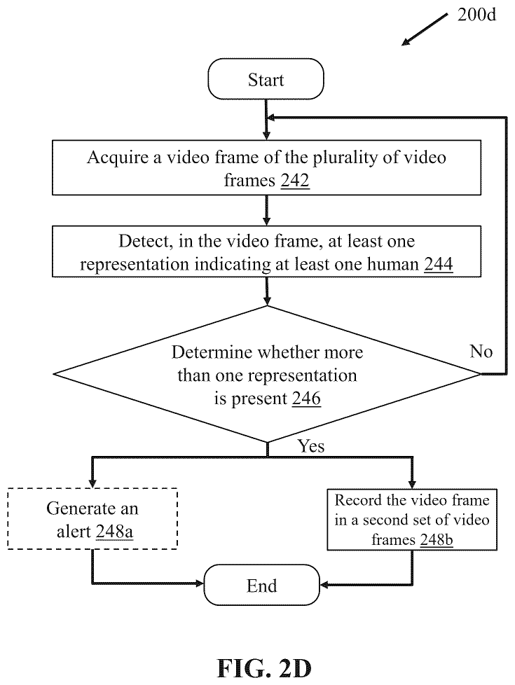

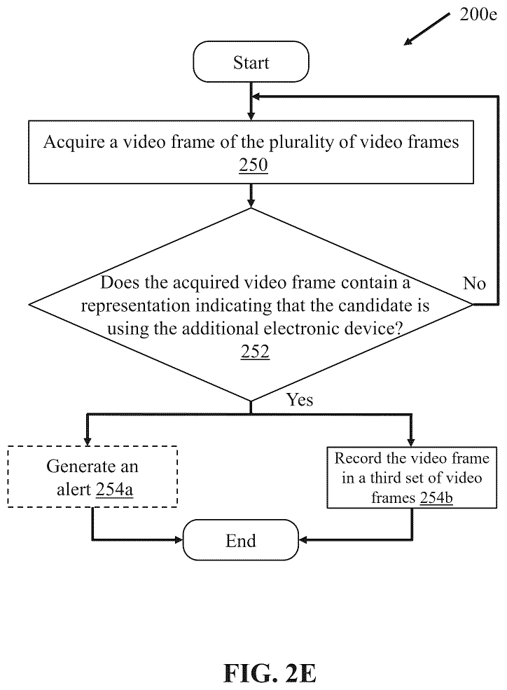

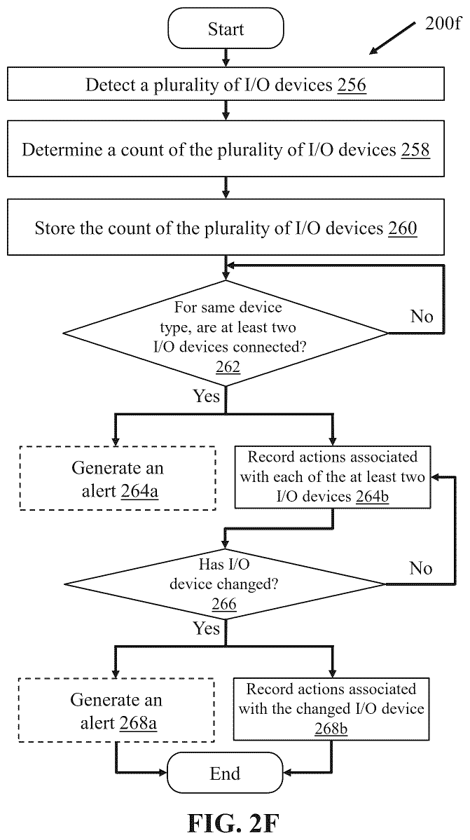

Here, for the purpose of illustration, one candidate terminal 102 and one recruiter terminal 104 are considered. However, in some example embodiments, there may be a plurality of candidate terminals and/or a plurality of recruiter terminals. In these example embodiments, each candidate terminal may be configured to identify whether the candidate associated with their corresponding candidate terminal is involved in the one or more malpractices. Here for the purpose of illustration, the candidate monitoring application 102d stored and executed on the candidate terminal 102 is considered. However, in some example embodiments, the candidate monitoring application 102d may be stored and executed on the recruiter terminal 104 and/or the server 108. Further, a process executed by the candidate terminal 102, upon execution of the candidate monitoring application 102d, will be described in detail with reference to FIG. 2A-FIG. 2F.

FIG. 2A illustrates a flowchart 200a depicting a process of the candidate monitoring application 102d, in accordance with an embodiment of the present disclosure. FIG. 2A is explained in conjunction with FIG. 1. In an embodiment, the candidate terminal 102 (e.g., the at least one processor 102a) may be configured to execute the candidate monitoring application 102d during the candidate interview. Upon execution of the candidate monitoring application 102d, the candidate terminal 102 may be configured to execute a series of operations 202-210 illustrated in FIG. 2A.

At 202, the candidate terminal 102 may be configured to acquire video data. In an embodiment, the video data may be acquired for a particular duration of time. For instance, the video data may be acquired for a specific time period or an entire time period of the candidate interview. For example, the specific time period may encompass the entire time period of the candidate interview. The video data may include a plurality of video frames. In an embodiment, the plurality of video frames may be acquired from the at least one software application that is currently running (or active) on the candidate terminal 102. For instance, the plurality of video frames may be acquired from the at least one software application via a Web Real-Time Communication (WebRTC) protocol or the like. In another embodiment, the plurality of video frames may be acquired from the one or more I/O devices (e.g., the camera) of the candidate terminal 102. As used herein, ‘video frame’ may correspond to an image frame captured by the camera of the candidate terminal 102 and/or an image of a screen (or a monitor) of the candidate terminal 102.

At 204, the candidate terminal 102 may be configured to store the acquired video data. For instance, the candidate terminal 102 may be configured to store the acquired video data in a database. In an embodiment, the acquired video data may be stored as a string in the database. In one embodiment, the database may be a part of the memory 102b. In another embodiment, the database may be realized in form of an entity that is separate from the memory 102b. For instance, the database may be a MongoDB database.

At 206, the candidate terminal 102 may be configured to determine proctored data based on the stored video data. In various embodiments, the determined proctored data may include a set of video frames, of the plurality of video frames, in which the candidate indulging in one or more malpractices are present. In an embodiment, the candidate terminal 102 may be configured to execute, using the stored video data, a plurality of detection processes to determine the proctored data. As used herein, ‘detection process’ may correspond to a method (or a process) for detecting a specific event. For instance, the plurality of detection processes may include a candidate feature detection process, an object detection process, a person detection process, and/or an I/O device detection process.

In an embodiment, the candidate feature detection process may be executed to identify whether the candidate is looking at a screen (or a monitor) of the candidate terminal 102 or not. In another embodiment, the candidate feature detection process may be executed to identify whether candidate's lips are in synchronization with an audio of the candidate or not. In yet another embodiment, the candidate feature detection process may be executed to identify candidate's mood (e.g., candidate's mental health) during the candidate interview. The object detection process may be executed to identify whether the candidate is using an additional electronic device. As used herein, ‘additional electronic device’ may be an electronic device used by the candidate in addition to the candidate terminal 102. For instance, the additional electronic device may include a mobile phone, a laptop, or the like. The person detection process may be executed to identify whether there is another person in the same room as the candidate. The I/O device detection process may be executed to identify a number of I/O devices connected to the candidate terminal 102.

According to some embodiments, execution of the plurality of detection processes may include execution of a plurality of models. In an embodiment, the candidate terminal 102 may be configured to execute the plurality of models to determine the proctored data. For example, the plurality of models may include Machine Learning (ML) models, Deep Learning (DL) models, and/or the like. As used herein, ‘model’ may correspond to a pre-trained ML/DL model that is configured to output a specific output. For instance, the plurality of models may be pre-trained to determine, from the plurality of video frames, a set of video frames in which the candidate is involved in one or more malpractices. In an embodiment, the proctored data may include the output of the plurality of models. For instance, the proctored data may include the set of video frames identified/outputted by the plurality of models. Further, execution of the plurality of detection processes will be explained in detail with reference to FIG. 2B-FIG. 2F.

FIG. 2B illustrates a flowchart 200b depicting a process for executing the plurality of detection processes, in accordance with an embodiment of the present disclosure. FIG. 2B is explained in conjunction with FIG. 1 and FIG. 2A. For instance, the candidate terminal 102 (e.g., the at least one processor 102a) may be configured to execute the candidate monitoring application 102d (e.g., the computer executable instructions) to execute a series of operations 212-226 illustrated in FIG. 2B.

At 212, the candidate terminal 102 may be configured to acquire candidate details. For instance, the candidate details may include name of the candidate, contact information of the candidate, permissions for utilizing the name and/or the contact information of the candidate, and/or the like. For example, the contact information may include a postal address of the candidate, an email address of the candidate, a mobile number of the candidate, and/or the like.

At 214, the candidate terminal 102 may be configured to determine whether the name of the candidate is present in the database. For instance, the database (and/or the memory 102b) may be configured to store candidate information corresponding to one or more reliable candidates. For example, the candidate information may include one or more names of the one or more reliable candidates, contact information of the one or more reliable candidates, and/or the like. As used herein, ‘reliable candidate’ may correspond a candidate who has participated in the candidate interview in the past without involving in one or more malpractices. In other words, the reliable candidate may correspond to a candidate who is ‘whitelisted’ by the recruiter. In an embodiment, the candidate terminal 102 may compare the name of the candidate with the one or more names stored in the database (and/or the memory 102b) to determine whether the name of the candidate is present in the database. In a case where the name of the candidate is present in the database, the candidate terminal 102 may proceed with 216.

At 216, the candidate terminal 102 may prohibit the acquisition of the plurality of video frames from the database. Since the name of the candidate is present in the database, the candidate terminal 102 may identify the candidate as the reliable candidate. Further, the candidate terminal 102 may stop identifying whether the candidate is involved in one or more malpractices. In a case where the name of the candidate is not present in the database, the candidate terminal 102 may proceed with 218. At 218, the candidate terminal 102 may be configured to acquire the plurality of video frames stored in the database (or the memory 102b).

At 220, the candidate terminal 102 may be configured to execute the candidate feature detection process. For instance, the candidate terminal 102 may execute the candidate feature detection process to identify whether the candidate is looking at the screen of the candidate terminal 102 or looking away from the screen of the candidate terminal 102. For example, the candidate feature detection process may be executed as explained in the detailed description of FIG. 2C.

FIG. 2C illustrates a flowchart 200c depicting the candidate feature detection process of the candidate monitoring application 102d, in accordance with an embodiment of the present disclosure. FIG. 2C is explained in conjunction with FIG. 1, FIG. 2A, and FIG. 2B. For instance, the candidate terminal 102 (e.g., the at least one processor 102a) may be configured to execute the candidate monitoring application 102d (i.e., the candidate feature detection process) to execute a series of operations 228-240b illustrated in FIG. 2C.

At 228, the candidate terminal 102 may be configured to acquire a video frame of the plurality of video frames. At 230, the candidate terminal 102 may be configured to identify whether the acquired video frame contains an image of (or a representation of) an eye of the candidate. For instance, the candidate terminal 102 may execute one or more pre-trained classifiers to identify whether the acquired video frame contains the image of the candidate's eye. For example, the one or more pre-trained classifiers may include cascade classifiers such as Haar feature-based cascade classifiers, or the like. In a case where it is identified that the acquired video frame does not contain the image of the candidate's eye, the candidate terminal 102 may proceed with 228. At 228, the candidate terminal 102 may be configured to acquire, from the plurality of video frames, a new video frame that is subsequent to the acquired video frame.

In a case where it is identified that the acquired video frame contains the image of the candidate's eye, the candidate terminal 102 may proceed with 232. That is to say, at 230, the candidate terminal 102 may be configured to identify a video frame, of the plurality of video frames, that contains the image of an eye of the candidate. At 232, the candidate terminal 102 may be configured to determine an eye position matrix in the identified video frame. As used herein, ‘eye position matrix’ may correspond to a matrix of a set of pixels of the identified video frame. For instance, the set of pixels may represent the image of the candidate's eye.

At 234, the candidate terminal 102 may be configured to determine one or more coordinates associated with the eye position matrix. For instance, the candidate terminal 102 may be configured to determine one or more coordinates of the set of pixels of the identified video frame as the one or more coordinates associated with the eye position matrix. As used herein, ‘coordinate’ may represent a position of a pixel of the video frame.

At 236, the candidate terminal 102 may be configured to determine one or more extended coordinates associated with the eye position matrix. For instance, the candidate terminal 102 may be configured to determine one or more coordinates of pixels surrounding the set of the pixels as the one or more extended coordinates associated with the eye position matrix.

At 238, the candidate terminal 102 may be configured to detect whether the identified video frame contains an image (or a representation) indicating that the candidate is looking away from the screen. In an embodiment, the candidate terminal 102 may be configured to execute a candidate feature detection model of the plurality of models to detect whether the identified video frame contains the image indicating that the candidate is looking away from the screen. For instance, the candidate feature detection model may receive at least one of the determined one or more coordinates, the determined one or more extended coordinates, pixel values associated with the determined one or more coordinates, and/or pixels values associated with the determined one or more extended coordinates as an input to detect whether the identified video frame contains the image indicating that the candidate is looking away from the screen.

In an embodiment, the candidate monitoring model may be a Gaze-Classifier model that is pre-trained to output a gaze class based on the received input. In one embodiment, the gaze class may be a probability indicating that the identified video frame contains the image, indicating that the candidate is looking away from the screen. In this example embodiment, the candidate terminal 102 may detect that the identified video frame contains the image indicating that the candidate is looking away from the screen, if the probability is greater than a threshold probability. In another embodiment, the gaze class may correspond to one or more of first gaze direction information, second gaze direction information, and/or third gaze direction information. The first gaze direction information may indicate that the identified video frame contains the image, indicating that the candidate is looking in the left direction. The second gaze direction information may indicate that the identified video frame contains the image, indicating that the candidate is looking at the screen. The third gaze direction information may indicate that the identified video frame contains the image, indicating that the candidate is looking in the right direction. In this example embodiment, the candidate terminal 102 may detect that the identified video frame contains the image indicating that the candidate is looking away from the screen, if the gaze class corresponds to the first gaze direction information and/or the third gaze direction information.

In a case where it is detected that the identified video frame contains the image indicating that the candidate is looking away from the screen, the candidate terminal 102 may proceed with 240a. At 240a, the candidate terminal 102 may be configured to generate, based on the detection that the identified video frame contains the image indicating that the candidate is looking away from the screen, an alert indicative of the candidate being involved in one or more malpractices. In some embodiments, the detection of the candidate looking away from the screen indicative of the candidate being involved in one or more malpractices may lead to the candidate being ‘blacklisted’ by the recruiter.

Although it is described that the candidate terminal 102 generates the alert, the scope of the present disclosure is not limited to it. In other embodiments, the candidate terminal 102 may optionally generate the alert indicative of the candidate being involved in one or more malpractices.

At 240b, the candidate terminal 102 may be configured to record the identified video frame in a first set of video frames.

In some example embodiment, at 240b, the candidate terminal 102 may further create a dequeue (double-ended queue) in the database (or the memory 102b) and store the outputted gaze class and a corresponding timestamp in the dequeue. In a case where it is detected that the identified video frame does not contain the image indicating that the candidate is looking away from the screen, the candidate terminal 102 may proceed with 228. At 228, the candidate terminal 102 may acquire the new video frame from the plurality of video frames.

In this way, the candidate terminal 102 may iteratively execute the flowchart 200c for each video frame of the plurality of video frames to obtain the first set of video frames from the plurality of video frames. For instance, the first set of video frames may include at least one video frame of the plurality of video frames in which the image indicating that the candidate is looking away from the screen is present. Further, the candidate terminal 102 may be configured to store the obtained first set of video frames in the database (or the memory 102b).

Referring now to FIG. 2B, at 222, the candidate terminal 102 may be configured to execute the person detection process of the plurality of detection processes. For instance, the candidate terminal 102 may execute the person detection process to identify whether there is another person in the same room as the candidate. For example, execution of the person detection process will be explained in the detailed description of FIG. 2D.

FIG. 2D illustrates a flowchart 200d depicting the person detection process of the candidate monitoring application 102d, in accordance with an embodiment of the present disclosure. FIG. 2D is explained in conjunction with FIG. 1, FIG. 2A, and FIG. 2B. For instance, the candidate terminal 102 (e.g., the at least one processor 102a) may be configured to execute the candidate monitoring application 102d (i.e., the person detection process) to execute a series of operations 242-248b illustrated in FIG. 2D.

At 242, the candidate terminal 102 may be configured to acquire a video frame of the plurality of video frames. At 244, the candidate terminal 102 may be configured to detect, in the acquired video frame, at least one representation indicating at least one human. In an embodiment, the candidate terminal 102 may be configured to execute a person detection model of the plurality of models to detect, in the acquired video frame, the at least one representation indicating the at least one human. For instance, the person detection model may receive the acquired video frame as an input to detect the at least one representation. In an embodiment, the person detection model may be a ML/DL model that is pre-trained to identify the at least one representation indicating the at least one human.

At 246, the candidate terminal 102 may be configured to determine whether more than one representation is present in the acquired video frame. In an embodiment, the candidate terminal 102 may further execute the person detection model to determine whether more than one representation is present in the acquired video frame. For instance, the person detection model may be further pre-trained to output, for the received input (for example, the acquired video frame), a probability indicating that more than one representation is present in the acquired video frame. The candidate terminal 102 may be configured to determine that more than one representation is present in the acquired video frame if the outputted probability is greater than a threshold probability.

In a case where it is determined that more than one representation is present in the acquired video frame, the candidate terminal 102 may proceed with 248a. At 248a, the candidate terminal 102 may be configured to generate, based on the determination that the acquired video frame contains more than one representation, an alert indicative of the candidate being involved in one or more malpractices.

In some embodiments, the determination of more than one representation in the acquired video frame indicative of the candidate being involved in one or more malpractices may lead to the candidate being ‘blacklisted’ by the recruiter.

Although it is described that the candidate terminal 102 generates the alert, the scope of the present disclosure is not limited to it. In other embodiments, the candidate terminal 102 may optionally generate the alert indicative of the candidate being involved in one or more malpractices.

At 248b, the candidate terminal 102 may be configured to record the acquired video frame in a second set of video frames. In a case where it is determined that more than one representation is not present in the acquired video frame, the candidate terminal 102 may proceed with 242. At 242, the candidate terminal 102 may acquire, from the plurality of video frames, a new video frame that is subsequent to the acquired video frame.

In this way, the candidate terminal 102 may iteratively execute the flowchart 200d for each video frame of the plurality of video frames to obtain the second set of video frames from the plurality of video frames. For instance, the second set of video frames may include at least one video frame of the plurality of video frames in which more than one representation is present in the acquired video frame. Further, the candidate terminal 102 may be configured to store the obtained second set of video frames in the database (or the memory 102b).

Referring now to FIG. 2B, at 224, the candidate terminal 102 may be configured to execute the object detection process of the plurality of detection processes. For instance, the candidate terminal 102 may execute the object detection process to identify whether the candidate is using the additional electronic device such as the mobile phone, the laptop, or the like. For example, execution of the object detection process will be explained in the detailed description of FIG. 2E.

FIG. 2E illustrates a flowchart 200e depicting the object detection process of the candidate monitoring application 102d, in accordance with an embodiment of the present disclosure. FIG. 2E is explained in conjunction with FIG. 1, FIG. 2A, and FIG. 2B. For instance, the candidate terminal 102 (e.g., the at least one processor 102a) may be configured to execute the candidate monitoring application 102d (i.e., the object detection process) to execute a series of operations 250-254b illustrated in FIG. 2E.

At 250, the candidate terminal 102 may be configured to acquire a video frame of the plurality of video frames. At 252, the candidate terminal 102 may be configured to determine whether the acquired video frame contains a representation indicating that the candidate is using the additional electronic device. In an embodiment, the candidate terminal 102 may be configured to execute an object detection model of the plurality of models to determine whether the acquired video frame contains the representation indicating that the candidate is using the additional electronic device. For instance, the object detection model may receive the acquired video frame as an input to determine whether the acquired video frame contains the representation indicating that the candidate is using the additional electronic device. In an embodiment, the object detection model may be a ML/DL model that is pre-trained to output, for the received input, a probability indicating that the acquired video frame contains the representation, indicating that the candidate is using the additional electronic device. The candidate terminal 102 may be configured to determine that the acquired video frame contains the representation indicating that the candidate is using the additional electronic device if the outputted probability is greater than a threshold probability.

In a case where it is determined that the acquired video frame contains the representation indicating that the candidate is using the additional electronic device, the candidate terminal 102 may proceed with 254a. At 254a, the candidate terminal 102 may be configured to generate, based on the determination that the acquired video frame contains the representation indicating that the candidate is using the additional electronic device, an alert indicative of the candidate being involved in one or more malpractices.

In some embodiments, the determination of the usage of the additional electronic device indicative of the candidate being involved in one or more malpractices may lead to the candidate being ‘blacklisted’ by the recruiter.

Although it is described that the candidate terminal 102 generates the alert, the scope of the present disclosure is not limited to it. In other embodiments, the candidate terminal 102 may optionally generate the alert indicative of the candidate being involved in one or more malpractices.

At 254b, the candidate terminal 102 may be configured to record the acquired video frame in a third set of video frames. In a case where it is determined that the acquired video frame does not contain the representation indicating that the candidate is using the additional electronic device, the candidate terminal 102 may proceed with 250. At 250, the candidate terminal 102 may acquire, from the plurality of video frames, a new video frame that is after the acquired video frame.

In this way, the candidate terminal 102 may iteratively execute the flowchart 200e for each video frame of the plurality of video frames to obtain the third set of video frames from the plurality of video frames. For instance, the third set of video frames may include at least one video frame of the plurality of video frames in which the representation indicating that the candidate is using the additional electronic device is present. Further, the candidate terminal 102 may be configured to store the obtained third set of video frames in the database (or the memory 102b).

Referring now to FIG. 2B, additionally or alternatively, the candidate terminal 102 may be configured to execute the I/O device detection process of the plurality of detection processes at 226. For instance, the candidate terminal 102 may execute the I/O device detection process to identify the number of I/O devices connected to the candidate terminal 102. For example, execution of the I/O device detection process will be explained in the detailed description of FIG. 2F.

FIG. 2F illustrates a flowchart 200f depicting the I/O device detection process of the candidate monitoring application 102d, in accordance with an embodiment of the present disclosure. FIG. 2F is explained in conjunction with FIG. 1, FIG. 2A, and FIG. 2B. For instance, the candidate terminal 102 (e.g., the at least one processor 102a) may be configured to execute the candidate monitoring application 102d (i.e., the I/O device detection process) to execute a series of operations 256-268b illustrated in FIG. 2F.

At 256, the candidate terminal 102 may be configured to detect that the candidate terminal 102 is connected to a plurality of I/O devices. For instance, the candidate terminal 102 may execute a plurality of I/O interface protocols to determine the plurality of I/O devices (such as the monitor, the mouse, the keyboard, the camera, the touchpad, the microphone, and/or the like) connected to the candidate terminal 102.

At 258, the candidate terminal 102 may be configured to determine a count of the plurality of I/O devices. For instance, the candidate terminal 102 may determine the count of the plurality of I/O devices as illustrated in table 1.

TABLE 1

| I/O devices | Count |
|---|---|
| Monitor | 1 |
| Mouse | 1 |
| Keyboard | 2 |
| Camera | 1 |

At 260, the candidate terminal 102 may be configured to store the determined count of the plurality of the I/O devices in the database (and/or the memory 102b). At 262, the candidate terminal 102 may be configured to determine whether at least two I/O devices, of the plurality of I/O devices, are associated with a same device type. For instance, the candidate terminal 102 may determine, based on the determined count, whether more than one mouse, one keyboard, and/or one camera is connected to the candidate terminal 102. In a case where it is determined that more than one I/O device is not connected, the candidate terminal 102 may proceed with 262 and may repeat 262 until it is determined that at least two I/O devices for the same device type are connected.

In a case where it is determined that more than one I/O device, i.e., at least two I/O devices are connected to the candidate terminal 102 for the same device type, the candidate terminal 102 may proceed with 264a. At 264a, the candidate terminal 102 may be configured to generate, based on the determination that at least two I/O devices are connected to the candidate terminal 102 for the same device type, an alert indicative of the candidate being involved in one or more malpractices. For instance, with respect to table 1, the candidate terminal 102 may determine, based on the count value, that two keyboards are connected to the candidate terminal 102.

In some embodiments, the determination of at least two I/O devices for the same device type being connected to the candidate terminal 102 indicative of the candidate being involved in one or more malpractices may lead to the candidate being ‘blacklisted’ by the recruiter.

Although it is described that the candidate terminal 102 generates the alert, the scope of the present disclosure is not limited to it. In other embodiments, the candidate terminal 102 may optionally generate the alert indicative of the candidate being involved in one or more malpractices.

At 264b, the candidate terminal 102 may be configured to record actions associated with each of the at least two I/O devices. For instance, the candidate terminal may record keystrokes associated with both keyboards. Further, the candidate terminal 102 may store the recorded actions in the database (and/or the memory 102b). At 266, the candidate terminal 102 may be configured to determine whether an I/O device, of the at least two I/O devices, is changed. For instance, the candidate terminal 102 may determine whether at least one connected keyboard is changed to a new keyboard and/or to a new I/O device.

In a case where it is determined that the I/O device is not changed, the candidate terminal 102 may proceed with 264b. At 264b, the candidate terminal 102 may continue the recording of the actions associated with each of the at least two I/O devices. In a case where it is determined that the I/O device is changed, the candidate terminal 102 may proceed with 268a. At 268a, the candidate terminal 102 may be configured to generate, based on the determination that the I/O device is changed, an alert indicative of the candidate being involved in one or more malpractices.

Although it is described that the candidate terminal 102 generates the alert, the scope of the present disclosure is not limited to it. In other embodiments, the candidate terminal 102 may optionally generate the alert indicative of the candidate being involved in one or more malpractices.

At 268b, the candidate terminal 102 may be configured to record actions associated with the changed I/O device. For instance, if the at least one connected keyboard is changed to a new keyboard, the candidate terminal 102 may be configured to record keystrokes associated with the new keyboard. Further, the candidate terminal 102 may be configured to store the recorded actions associated with the changed I/O device in the database (and/or the memory 102b).

In this way, the candidate terminal 102 may be configured to execute one or more of the candidate feature detection process, the object detection process, the person detection process, and/or the I/O device detection process to determine the proctored data. In an embodiment, the determined proctored data may include one or more outputs of the candidate feature detection process, the object detection process, the person detection process, and/or the I/O device detection process. For instance, the determined proctored data may include the first set of video frames, the second set of video frames, the third set of video frames, the count of the one or more I/O devices, and/or the actions associated with the I/O devices. That is to say, the set of video frames, of the plurality of video frames, in which the candidate indulging in one or more malpractices may correspond to at least one of the first set of video frames, the second set of video frames, the third set of video frames, the count of the one or more I/O devices, and/or the actions associated with the I/O devices.

Referring now to FIG. 2A, at 208, the candidate terminal 102 may be configured to generate at least one report based on the determined proctored data.

That is to say, the at least one report may include the first set of video frames, the second set of video frames, the third set of video frames, the count of the one or more I/O devices, and/or the actions associated with the I/O devices. In some embodiments, the at least one report may include the actions associated with the changed I/O device.

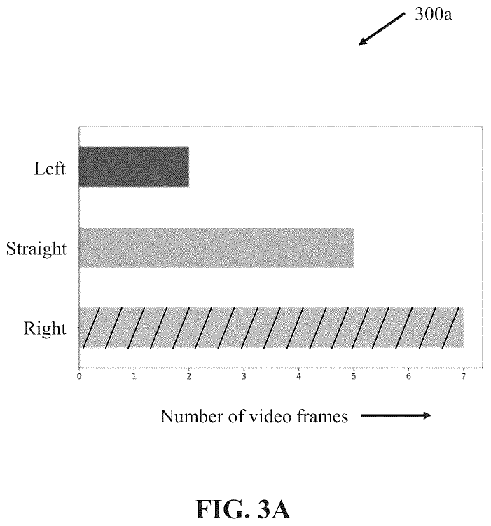

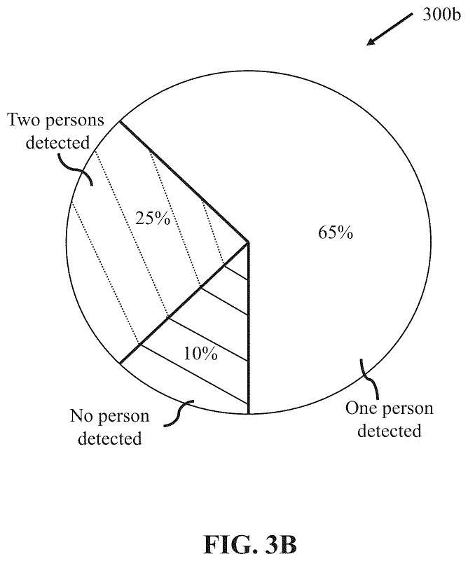

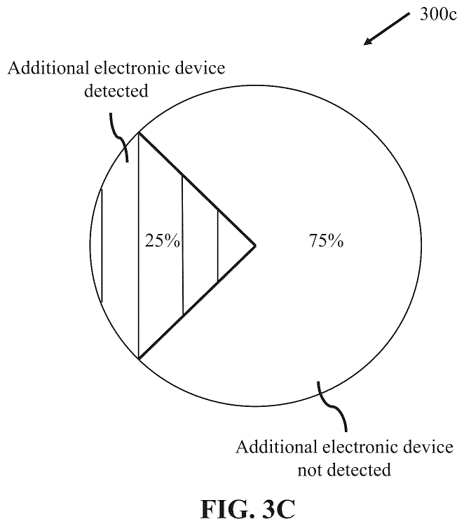

For instance, the generated report may include one or more representations depicting the one or more outputs of the candidate feature detection process, the person detection process, the object detection process, and/or the I/O device detection process. For example, the representations depicting the outputs of the candidate feature detection process, the person detection process, and the object detection process are as illustrated in FIG. 3A-FIG. 3C, respectively.

FIG. 3A illustrates a representation 300a depicting an output of the candidate feature detection process, in accordance with an embodiment of the present disclosure. For instance, the representation 300a is a bar graph with the x-axis being a number of video frames and the y-axis being at least one gaze direction. As illustrated in the representation 300a, the plurality of video frames may include fourteen video frames. In the fourteen video frames, five video frames may include the image (or the representation) indicating that the candidate is looking at the screen and nine video frames may include the image indicating that the candidate is looking away from the screen. For instance, the first set of video frames may include the nine video frames. In the nine video frames, two video frames may include the image indicating that the candidate is looking in the left direction and seven video frames may include the image indicating that the candidate is looking in the right direction.

Here for the purpose of illustration, the representation 300a is illustrated with the bar graph. However, the representation 300a may be illustrated with a pie chart, a histogram, and/or any other suitable representation without deviating from the scope of the present disclosure.

FIG. 3B illustrates a representation 300b depicting an output of the person detection process, in accordance with an embodiment of the present disclosure. For instance, the representation 300b is a circle graph that represents twenty-five percent of video frames indicating that more than one person is present in the same room as the candidate, ten percent of video frames indicating that the candidate is not detected, and sixty-five percent of video frames indicating that only the candidate is present. For example, if the plurality of video frames includes twenty video frames, five video frames of the twenty video frames may indicate that more than one person is present. For instance, the second set of video frames may include the five video frames that indicate more than one person is present.

Here for the purpose of illustration, the representation 300b is illustrated with the circle graph. However, the representation 300b may be illustrated with a histogram, a bar graph, and/or any other suitable representation without deviating from the scope of the present disclosure.

FIG. 3C illustrates a representation 300c depicting an output of the object detection process, in accordance with an embodiment of the present disclosure. For instance, the representation 300c is a circle graph that represents twenty-five percent of video frames indicating that the candidate is using the additional electronic device and seventy-five percent of video frames indicating that the candidate is not using the additional electronic device. For example, if the plurality of video frames includes twenty video frames, five video frames of the twenty video frames may indicate the candidate is using the additional electronic device. For instance, the third set of video frames may include the five video frames that indicate the candidate is using the additional electronic device.

Here for the purpose of illustration, the representation 300c is illustrated with the circle graph. However, the representation 300c may be illustrated with a histogram, a bar graph, and/or any other suitable representation without deviating from the scope of the present disclosure.

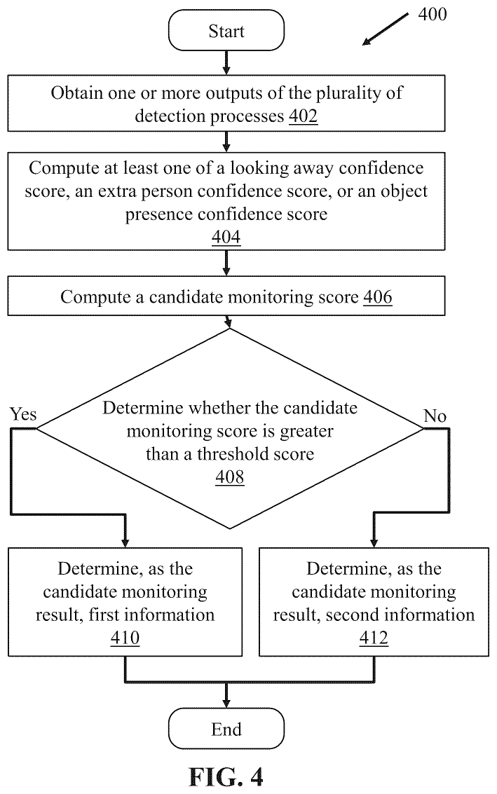

In this way, the candidate terminal 102 may generate the one or more representations (such as the representation 300a, the representation 300b, the representation 300c, etc.,) using the plurality of video frames and the one or more outputs of the plurality of detection processes. Further, the candidate terminal 102 may include the generated one or more representations in the at least one report. Additionally (or alternatively), in some embodiments, the generated at least one report may include a candidate monitoring result. For instance, the candidate monitoring result may include one of first information indicating that the candidate is involved in the one or more malpractices or second information indicating that the candidate is not involved in the one or more malpractices. In an embodiment, the candidate terminal 102 may be configured to execute the candidate monitoring application 102d to determine the candidate monitoring result. For example, determination of the candidate monitoring result will be explained in the detailed description of FIG. 4.

FIG. 4 illustrates a flowchart 400 depicting a process for determining the candidate monitoring result, in accordance with an embodiment of the present disclosure. FIG. 4 is explained in conjunction with FIG. 1 and FIG. 2A-FIG. 2F. For instance, the candidate terminal 102 (e.g., the at least one processor 102a) may be configured to execute the candidate monitoring application 102d to execute a series of operations 402-412 illustrated in FIG. 4.

At 402, the candidate terminal 102 may be configured to obtain the one or more outputs of the plurality of detection processes. For instance, the candidate terminal 102 may obtain the first set of video frames, the gaze classes associated with the first set of video frames, the second set of video frames, the third set of video frames, the count of the I/O devices, and/or the like.

At 404, the candidate terminal 102 may be configured to compute one or more of a looking away confidence score, an extra person confidence score, or an object presence confidence score. In an embodiment, the one or more of the looking away confidence score, the extra person confidence score, or the object presence confidence score may be computed based on the obtained one or more outputs of the plurality of detection processes.

In one embodiment, the candidate terminal 102 may compute the looking away confidence score based on the gaze classes associated with the first set of video frames. For example, the candidate terminal 102 may compute the looking away confidence score as shown in equation 1:

$$looking away confidence score = \frac{\sum gaze classes in the queue}{length of the queue} \qquad Equation ( 1 )$$

where ‘Σ gaze classes in the queue’ may represent a summation of all the gaze classes stored in the queue and ‘length of the queue’ may represent a number of the gaze classes stored in the queue.

In another embodiment, the candidate terminal 102 may determine, using the first set of video frames, a time period for which the candidate is looking away from the screen. Further, the candidate terminal 102 may determine whether the determined time period is equal to or greater than a specific time period (e.g., 5 seconds or the like). In a case where it is determined that the determined time period is equal to or greater than the specific time period, the candidate terminal 102 may determine the looking away confidence score as high (e.g., a Boolean value of ‘1’). In a case where it is determined that the determined time period is less than the specific time period, the candidate terminal 102 may determine the looking away confidence score as low (e.g., a Boolean value of ‘0’).

In one embodiment, the candidate terminal 102 may determine the extra person confidence score as high (e.g., a Boolean value of ‘1’) when a number of video frames in the second set of video frames is one or greater than one. Alternatively, when the second set of video frames corresponds to a null set, then the candidate terminal 102 may determine the extra person confidence score as low (e.g., a Boolean value of ‘0’).

According to another embodiment, each video frame of the second set of video frames may be associated with a probability value indicating that more than one human is present. In this example embodiment, the extra person confidence score may be computed as an average (or mean) of the probability value of each video frame of the second set of video frames.

In one embodiment, the candidate terminal 102 may determine the object presence confidence score as high (e.g., a Boolean value of ‘1’) when a number of video frames in the third set of video frames is one or greater than one. Alternatively, when the third set of video frames corresponds to a null set, then the candidate terminal 102 may determine the object presence confidence score as low (e.g., a Boolean value of ‘0’).

According to another embodiment, each video frame of the third set of video frames may be associated with a probability value indicating that the candidate is using the additional electronic device. In this example embodiment, the object presence confidence score may be computed as an average (or mean) of the probability value of each video frame of the third set of video frames.

At 406, the candidate terminal 102 may be configured to compute a candidate monitoring score based on one or more weights and the one or more of the looking away confidence score, the extra person confidence score, or the object presence confidence score. For instance, each confidence score of the one or more of the looking away confidence score, the extra person confidence score, or the object presence confidence score may be associated with a respective weight of the one or more weights. For example, the candidate terminal 102 may compute the candidate monitoring score as shown in equation 2:

$$\begin{matrix}candidate monitoring score = ( {w}_{1} \cdot looking away confidence score ) + \\ ( {w}_{2} \cdot extra person confidence score ) + ( {w}_{3} \cdot object presence confidence score )\end{matrix} \qquad Equation ( 2 )$$

where w₁, w₂, and w₃ may correspond to the one or more weights. In some example embodiments, the one or more weights may be determined based on importance of each confidence score of the one or more of the looking away confidence score, the extra person confidence score, or the object presence confidence score. Further, the one or more weights may be determined such that false positives and false negatives are reduced in the identification of whether the candidate is involved in the one or more malpractices.

At 408, the candidate terminal 102 may be configured to determine whether the determined candidate monitoring score is greater than a threshold score. For instance, the candidate terminal 102 may compare the determined candidate monitoring score with the threshold score to determine whether the candidate monitoring score is greater than the threshold score. For example, the threshold score may be determined such that the false positives and the false negatives are reduced in the identification of whether the candidate is involved in the one or more malpractices.

In a case where it is determined that the candidate monitoring score is greater than the threshold score, the candidate terminal 102 may proceed with 410. At 410, the candidate terminal 102 may be configured to determine, as the candidate monitoring result, the first information indicating that the candidate is involved in the one or more malpractices. In a case where it is determined that the candidate monitoring score is not greater than the threshold score, the candidate terminal 102 may proceed with 412. At 412, the candidate terminal 102 may be configured to determine, as the candidate monitoring result, the second information indicating that the candidate is not involved in the one or more malpractices.

In this way, the candidate terminal 102 may determine the candidate monitoring result based on the one or more outputs of the plurality of detection processes. Further, the candidate terminal 102 may include the determined candidate monitoring result in the at least one report.

Referring now to FIG. 2A, at 210, the candidate terminal 102 may be configured to transmit the at least one report to the recruiter terminal 104. For instance, the at least one report may be transmitted to the recruiter terminal 104 via an email or the like. For example, the transmitted report may include the one or more representations (such as the representations 300a-300c) and/or the candidate monitoring result. At 210, in some example embodiments, the candidate terminal 102 may be further configured to transmit, to the recruiter terminal 104, the first set of video frames, the second set of video frames, the third set of video frames, the count of the I/O devices, and/or the like. Additionally (or alternatively), in some example embodiments, the candidate terminal 102 may be further configured to output the at least one report via one or more output devices of the candidate terminal 102 (at 210). For instance, the one or more output devices of the candidate terminal 102 may include the screen, the monitor, the speaker, and/or the like. In some other example embodiments, at 210, the candidate terminal 102 may be further configured to transmit the at least report to the server 108.

In this way, the candidate terminal 102 may identify whether the candidate is involved in the one or more malpractices or not, and may transmit the candidate monitoring result to the recruiter terminal 104. Thereby, the employer (or a recruiter) associated with the recruiter terminal 104 is provided with the candidate monitoring result which in turn enables the employer to decide whether to consider the candidate for one or more jobs associated with the employer. Accordingly, the candidate terminal 102 enables filtering out false candidate(s) in an employee recruitment process. Therefore, the candidate terminal 102 improves productivity and resource planning for the employer. As used herein, ‘false candidate’ may correspond to a candidate who is involved in the one or more malpractices. As used herein, ‘employee recruitment process’ may correspond to a process of hiring one or more candidates for one or more jobs associated with the employer.

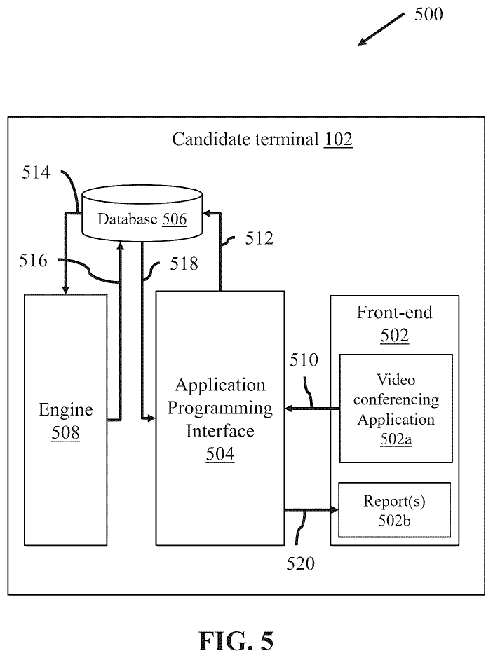

FIG. 5 illustrates a workflow 500 for monitoring the candidate using the candidate terminal 102, in accordance with an embodiment of the present disclosure. FIG. 5 is explained in conjunction with FIG. 1, FIG. 2A-FIG. 2F, FIG. 3A-FIG. 3C, and FIG. 4. In an embodiment, the at least one processor 102a of the candidate terminal 102 may be configured to function as a front-end 502, an application programming interface 504, and/or an engine 508. In an embodiment, the memory 102b may be configured as a database 506. The database 506 may be configured to store data and/or information associated with the candidate monitoring application 102d and/or a video conferencing application 502a.

In operation, the at least one processor 102a may acquire the video data, including the plurality of video frames, from the video conferencing application 502a at 510. For instance, the video data may be acquired as explained in the detailed description of FIG. 2A. At 512, the at least one processor 102a may store the acquired video data in the database 506. For instance, the video data may be stored in the database 506 as explained in the detailed description of FIG. 2A. At 514, the at least processor 102a may acquire the stored video data. For instance, the at least one processor 102a may acquire the stored video data as explained in the detailed description of FIG. 2B. At 516, the at least one processor 102a may determine the proctored data based on the stored video data. For instance, the proctored data may be determined as explained in the detailed description of FIG. 2A-FIG. 2F. At 516, the at least one processor 102a may further store the determined proctored data in the database 506. At 518, the at least processor 102a may acquire the stored proctored data. At 520, the at least processor 102a may generate at least one report 502b based on the proctored data. For instance, the at least one report 502b may be generated as explained in the detailed description of FIG. 3A-FIG. 3C and FIG. 4. At 520, the at least one processor 102a may further transmit the at least one report 502b to the recruiter terminal 104.

While various embodiments of the present disclosure have been illustrated and described, it will be clear that the present disclosure is not limited to these embodiments only. Numerous modifications, changes, variations, substitutions, and equivalents will be apparent to those skilled in the art, without deviating from the scope of the present disclosure.

What is claimed is:

1. A system, comprising:
a memory configured to store computer-executable instructions; and
at least one processor coupled to the memory, wherein the at least one processor is configured to execute the computer-executable instructions to:
acquire video data comprising a plurality of video frames of a candidate;
determine, based on the acquired video data, proctored data, wherein the proctored data includes a set of video frames of the plurality of video frames, and wherein the set of video frames is indicative of the candidate being involved in one or more malpractices;
generate, based on the proctored data, at least one report; and
transmit, the generated at least one report to a recruiter associated with the candidate.

2. The system of claim 1, wherein the at least one processor is further configured to execute the computer-executable instructions to:
identify a video frame, of the plurality of video frames, that contains an image of an eye of the candidate;
determine an eye position matrix in the identified video frame and at least one of a group consisting of (i) one or more coordinates associated with the eye position matrix, or (ii) one or more extended coordinates associated with the eye position matrix;
detect, based on the at least one of the group consisting of (i) the one or more coordinates or (ii) the one or more extended coordinates, that the identified video frame contains an image indicating that the candidate is looking away from a screen of a candidate terminal; and
record, based on the detection that the identified video frame contains the image indicating that the candidate is looking away from the screen of the candidate terminal, the identified video frame in the set of video frames.

3. The system of claim 2, wherein the at least one report includes the set of video frames.

4. The system of claim 2, wherein the at least one processor is further configured to execute the computer-executable instructions to:
generate, based on the detection that the identified video frame contains the image indicating that the candidate is looking away from the screen of the candidate terminal, an alert indicative of the candidate being involved in the one or more malpractices.

5. The system of claim 2, wherein the at least one processor is further configured to execute the computer-executable instructions to:
output, based on the at least one of the group consisting of (i) the one or more coordinates associated with the eye position matrix or (ii) the one or more extended coordinates associated with the eye position matrix, a gaze class, wherein the gaze class is a probability indicating that the identified video frame contains the image, indicating that the candidate is looking away from the screen of the candidate terminal.

6. The system of claim 2, wherein the at least one processor is further configured to execute the computer-executable instructions to:
output, based on the at least one of the group consisting of (i) the one or more coordinates associated with the eye position matrix or (ii) the one or more extended coordinates associated with the eye position matrix, a gaze class, wherein the gaze class corresponds to one or more of
(i) first gaze direction information, wherein the first gaze direction information indicates that the identified video frame contains the image indicating that the candidate is looking in a left direction,
(ii) second gaze direction information, wherein the second gaze direction information indicates that the identified video frame contains the image indicating that the candidate is looking at the screen of the candidate terminal, or
(iii) third gaze direction information, wherein the third gaze direction information indicates that the identified video frame contains the image, indicating that the candidate is looking in a right direction, and
wherein the detection that the identified video frame contains the image indicating that the candidate is looking away from the screen, of the candidate terminal, is further based on the gaze class corresponding to at least the first gaze direction information or the third gaze direction information.

7. The system of claim 1, wherein the at least one processor is further configured to execute the computer-executable instructions to:
acquire a video frame of the plurality of video frames;
determine that more than one representation is present in the acquired video frame; and
record, based on the determination that the acquired video frame contains more than one representation, the acquired video frame in the set of video frames.

8. The system of claim 7, wherein the at least one report includes the set of video frames.

9. The system of claim 7, wherein the at least one processor is further configured to execute the computer-executable instructions to:
generate, based on the determination that the acquired video frame contains more than one representation, an alert indicative of the candidate being involved in the one or more malpractices.

10. The system of claim 1, wherein the at least one processor is further configured to execute the computer-executable instructions to:
acquire a video frame of the plurality of video frames;
determine that the acquired video frame contains a representation indicating that the candidate is using an additional electronic device; and
record, based on the determination that the acquired video frame contains the representation indicating that the candidate is using the additional electronic device, the acquired video frame in the set of video frames.

11. The system of claim 10, wherein the at least one report includes the set of video frames.

12. The system of claim 10, wherein the at least one processor is further configured to execute the computer-executable instructions to:
generate, based on the determination that the acquired video frame contains the representation indicating that the candidate is using the additional electronic device, an alert indicative of the candidate being involved in the one or more malpractices.

13. The system of claim 1, wherein the at least one processor is further configured to execute the computer-executable instructions to:
detect that a candidate terminal is connected to a plurality of I/O devices;
determine that at least two I/O devices, of the plurality of I/O devices, are associated with a same device type; and
record actions associated with each of the at least two I/O devices, wherein the proctored data includes the recorded actions associated with each of the at least two I/O devices.

14. The system of claim 13, wherein the at least one report includes the actions associated with each of the at least two I/O devices.

15. The system of claim 13, wherein the at least one processor is further configured to execute the computer-executable instructions to:
generate, based on the determination that the at least two I/O devices are connected to the candidate terminal for the same device type, an alert indicative of the candidate being involved in the one or more malpractices.

16. The system of claim 13, wherein the at least one processor is further configured to execute the computer-executable instructions to:
determine that a first I/O device of the at least two I/O devices is changed; and
record actions associated with the changed first I/O device, wherein the proctored data includes the recorded actions associated with the changed first I/O device,
wherein the at least one report includes the actions associated with the changed first I/O device.

17. The system of claim 16, wherein the at least one processor is further configured to execute the computer-executable instructions to:
generate, based on the determination that the first I/O device is changed, an alert indicative of the candidate being involved in the one or more malpractices.

18. The system of claim 1, wherein the at least one processor is further configured to execute the computer-executable instructions to:
compute, based on the proctored data, at least one of a looking away confidence score, an extra person confidence score, or an object presence confidence score;
compute, based on the at least one of the looking away confidence score, the extra person confidence score, or the object presence confidence score, a candidate monitoring score; and
determine, based on the candidate monitoring score being greater than a threshold score, first information, wherein the first information is indicative of the candidate being involved in the one or more malpractices.

19. The system of claim 18, wherein the at least one report includes the first information.

20. A method for monitoring a candidate during an interview process, the method comprising:
acquiring, by at least one processor, video data comprising a plurality of video frames of the candidate;
determining, by the at least one processor, based on the acquired video data, proctored data, wherein the proctored data includes a set of video frames of the plurality of video frames, and wherein the set of video frames is indicative of the candidate being involved in one or more malpractices;
generating, by the at least one processor, based on the proctored data, at least one report; and
transmitting, by the at least one processor, the generated at least one report to a recruiter associated with the candidate.
